(19) United States
(12) Patent Application Publication
(10) Pub. No.: US 2010/0306348 A1
(43) Pub. Date: Dec. 2, 2010

(54) METHOD AND SYSTEM FOR DISPLAYING AND COMPARING STORAGE ZONING CONFIGURATIONS

(75) Inventors: Andreas Dieberger, Los Gatos, CA (US); Eben Merriam Haber, Cupertino, CA (US)

Correspondence Address: CANTOR COLBURN LLP - IBM ARC DIVISION, 20 Church Street, 22nd Floor, Hartford, CT, 06103, US

(73) Assignee: International Business Machines Corporation, Armonk, NY (US)

(21) Appl. No.: 12/475,563

(22) Filed: May 31, 2009

(51) Int. Cl. G06F 15/177

(52) U.S. Cl. 709/220

(57) ABSTRACT

According to one embodiment of the present invention, a method for displaying and comparing storage zoning configurations is provided. The method comprises generating a table representing data paths between a plurality of source and target devices in a storage area network. Symbols are added symbols to the table, the symbols indicating whether communication between particular source and target devices along a particular data path is permitted, or not permitted, according to defined zone sets. The portions of the table may be sorted according to at least one desired parameter using a user interface. Also, a new zone set may be defined in response to a change in at least one of the values in the table made through a user interface.

### BACKGROUND

The present invention relates to user interfaces, and more specifically, to a user interface for displaying and comparing storage zoning configurations.

In the past, computer storage was limited to the use of disks attached to computers. More recently, Storage Area Networks (SANs) became popular. In SANs, multiple host computers can access disks on large storage subsystems via a high-speed fibre channel switched network (a “fabric”). “Zoning” is a term describing several techniques for improving security and/or performance by limiting which storage subsystems are accessible from which hosts. One of the most common forms of zoning is referred to as “WWN Zoning” or “Soft Zoning”, this type of zoning is based on the WWN (a unique identifier) for the network ports of the computer hosts and storage subsystems. With WWN Zoning, zones are defined as sets of WWNs that are allowed to communicate with each other. Zones may be grouped into zone sets, where only one zone set is active at a given time.

Zoning and zone set information is typically displayed to users to facilitate understanding and modifying zone sets. Zoning information is typically displayed as membership lists. These lists show which WWNs are members of which zones, and which zones are members of which zone sets.

### SUMMARY

According to one embodiment of the present invention, a method comprises: generating a table representing data paths between a plurality of source and target devices in a storage area network; adding symbols to the table, the symbols indicating whether communication between particular source and target devices along a particular data path is permitted, or not permitted, according to defined zone sets; and sorting portions of the table according to at least one desired parameter using a user interface.

According to another embodiment of the present invention, a method comprises: generating a table representing data paths between a plurality of source and target devices in a storage area network; adding values to the table indicating whether communication between the source and the target devices along a particular data path is permitted, or not permitted according to defined zone sets; and defining a new zone set in response to a change in at least one of the values in the table made through a user interface.

According to a further embodiment of the present invention, a system comprises: a storage area network including at least one source device and at least one target device; a display showing a table representing the source and target devices, the table representing data paths between a plurality of source and target devices in a storage area network, the table including symbols indicating whether communication between particular source and target devices along a particular data path is permitted, or not permitted, according to defined zone sets; and a user interface for modifying the table.

According to another embodiment of the present invention, a computer program product for displaying and comparing storage zoning configurations comprises: a computer usable medium having computer usable program code embodied therewith, the computer usable program code comprising: computer usable program code configured to: generate a table representing data paths between a plurality of source and target devices in a storage area network; add values to the table indicating whether communication between the source and the target devices along a particular data path is permitted, or not permitted according to defined zone sets; and define a new zone set in response to a change in at least one of the values in the table made through a user interface.

### BRIEF DESCRIPTION OF THE SEVERAL VIEWS OF THE DRAWINGS

FIG. 1 shows a diagram of a storage area network in accordance with an embodiment of the invention;

FIG. 2 shows a diagram of a computer network including a storage area network in accordance with an embodiment of the invention;

FIG. 3 shows a diagram of a relationship visualization system in accordance with an embodiment of the invention;

FIG. 4 shows initiator, fabric and target entities in accordance with an embodiment of the invention;

FIG. 5 shows a diagram illustrating a screen shot of a display of the entities shown in FIG. 4 in accordance with an embodiment of the invention;

FIG. 6 shows a tabular display of data paths showing the effect of a zone as Boolean values in accordance with an embodiment of the invention; and

FIG. 8 shows a high level block diagram of an information processing system useful for implementing one embodiment of the present invention.

### DETAILED DESCRIPTION

Embodiments of the invention provide a user interface that displays zoning information in a manner which shows the effect of a zone set as Boolean values. This allows users to compare multiple zone sets in multiple columns by simply placing them next to each other. By comparing the values in the columns it is easy to see the differences in what is permitted by two or more zone sets. In prior systems zoning information was shown as membership lists, which made it more difficult to see the differences in what was permitted by multiple zone sets.

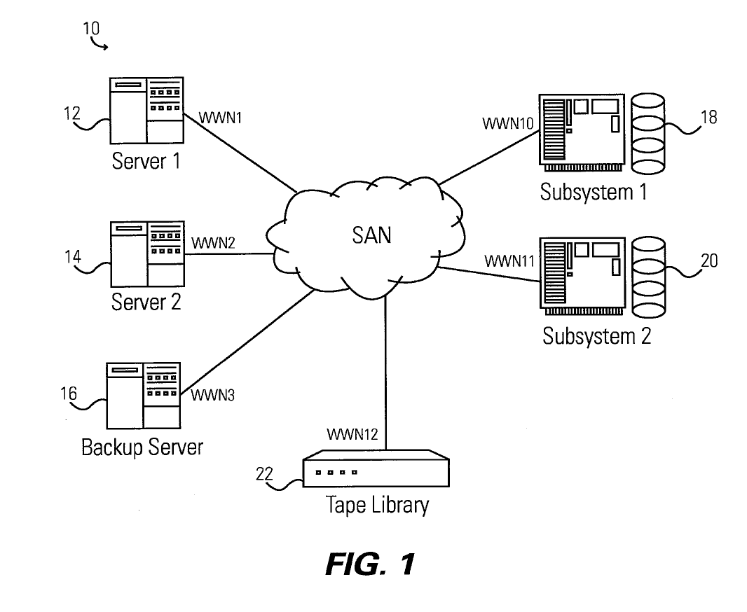

FIG. 1 shows an exemplary SAN system 10, including three hosts 12, 14 and 16, two storage subsystems 18 and 20, and a tape backup system 22. Each device has a unique identifier, here indicated as WWN<number>. Consider the case where, during normal operation, Server 1 is only allowed to talk to Subsystem 1, Server 2 is only allowed to talk to Subsystem 2, and nobody talks to the Backup Server 16 or Tape Library 22.

One zone would be defined as: (WWN1, WWN10) to permit Server 1 and Subsystem 1 to talk. Another zone would be defined as: (WWN2, WWN11) for Server 2 and Subsystem 2. These two zones would be combined into a Zone Set, which would be in effect during normal operations, e.g., Regular Zone Set={(WWN1, WWN10), (WWN2, WWN11)}.

Data center needs are not static, however. For example, in some systems every night at midnight, it is necessary for the backup server to access all the disks on the subsystems, and back them up to the tape library. To prevent the other servers from slowing down the backup process, it is desirable to prevent them from accessing the disk subsystems during this time. To accomplish this, a new zone is defined as: (WWN3, WWN10, WWN11, WWN12). This zone is the sole member of a Zone Set that is in effect during backup, e.g., Backup Zone Set={(WWN3, WWN10, WWN11, WWN12)}

Thus SAN Zoning can be summarized as follows: 1) WWN Zoning is used to limit communications between certain devices attached to a SAN; 2) a Zone is defined as a set of one or more WWNs of devices that are allowed to communicate; and 3) Zones are grouped into Zone Sets, and only one Zone Set is active at any given time.

As a technology for managing SANs, conventional zoning works well. However, there is a problem with zoning when it comes to the specification and management of zones. Since a zone is a set of WWNs, it is commonly built and displayed as a list. While the implications of connectivity between members of a single list are straightforward to understand, the fact that a WWN may be a member of multiple zones, and a zone may be a member of multiple zone sets, can make the implications of zoning decisions very hard to understand. Given a display of a list of WWNs in each zone, and a list of each zone in each zone set, it can be difficult for the user to ensure that the zoning allows all access that it should, and prevents access that it shouldn't. This problem is compounded by the scale of modern systems, containing hundreds or thousands of servers and subsystems. Being over permissive with zoning results in security problems and potential failures due to the wrong host accessing a particular storage system. Being overly restrictive with zoning can prevent applications from functioning at all.

To ensure that a zone set allows connectivity between two or more WWNs, one must search for them in every zone. If they aren't present, the user must decide between adding a new zone with just those WWNs (the safest choice, though it leads to a higher number of zones), or adding the WWNs to an existing zone (which is potentially error-prone, since all members of a zone can communicate with each other, and this may not be the intended behavior).

To ensure that a zone set prohibits connectivity between two or more WWNs, the user must search through every existing zone to ensure that the combination of WWNs does not exist in any of them. This process can be error prone if there are many zones, or if the zones contain many devices. In addition, removing a device from a large zone may have unanticipated consequences, since it prevents connectivity with any other device in the zone.

While attempting to insure that a zone set allows and prohibits the correct connectivity, errors can creep in since a zone can be a member of more than one zone set, so a user might unintentionally change several zone sets while attempting to modify only one.

In addition to difficulties in managing connectivity through zone/zone set specifications, conventional approaches can also make it extremely difficult to compare two zone sets. There are many ways to define the same connectivity using sets of WWNs, and determining the differences between what is allowed or permitted between two zone sets is highly labor-intensive. This is because the user must essentially test each zone set for each connectivity pair to see whether it is supported or prohibited. Attempts have been made to visualize zone and zone set membership as an overlay on the display of a SAN's topology. These attempts have been largely unsuccessful because zone membership is complex—any device can be a member of multiple zones, which might be members of multiple zone sets. Visualizing and understanding zone sets using such a display is extremely difficult due to the overlap involved.

Another problem with existing zoning specifications is that they do not handle the case of multiple SAN fabrics. To provide redundancy, SANs are frequently divided into completely independent “fabrics” (collections of SAN switches). Computer servers and storage subsystems are plugged into two or more fabrics to give completely independent connections in case a problem disables a single SAN fabric. Yet existing zoning techniques do not support multiple fabrics in any meaningful way: the user must define separate zones and zone sets for each SAN fabric, and ensure that they work consistently.

Embodiments of the present invention utilize a new representation of zone set information for displaying and modifying zone sets. As described above, zoning information is typically shown as membership lists: which WWNs are members of which zones, and which zones are members of which zone sets. In contrast, embodiments of the present invention focuses on showing the effect of a Zone Set, without trying to display the membership or topology of all zones or zone sets.

In one embodiment, the representation of zones or zone sets relies on a tabular display of data paths based on host or storage subsystem network ports. One example of a tabular display of data paths is described in U.S. patent application Ser. No. ______, entitled “System and Method for Disclosing Relations Between Entities in Support of Information Technology System Visualization and Management”, the contents of which are hereby incorporated by reference in its entirety for all purposes and uses. In the tabular display of data paths shown in this incorporated by reference patent application, for every port shown the representation shows all possible connections between a host port to a storage subsystem network ports. This means that every row in the table shows a complete data path as a host port/subsystem port pair. This data path display is extended in embodiments of the present invention to represent the effect of a zone as Boolean values. For example, the Boolean value may express whether communication is permitted along a particular path or not. This simple representation thus allows users to compare multiple zone sets (multiple columns) by simple placing them next to each other. By comparing the values in the columns it is easy to see the differences in what is permitted by two or more zone sets. This task would be much harder with the common list-based representation.

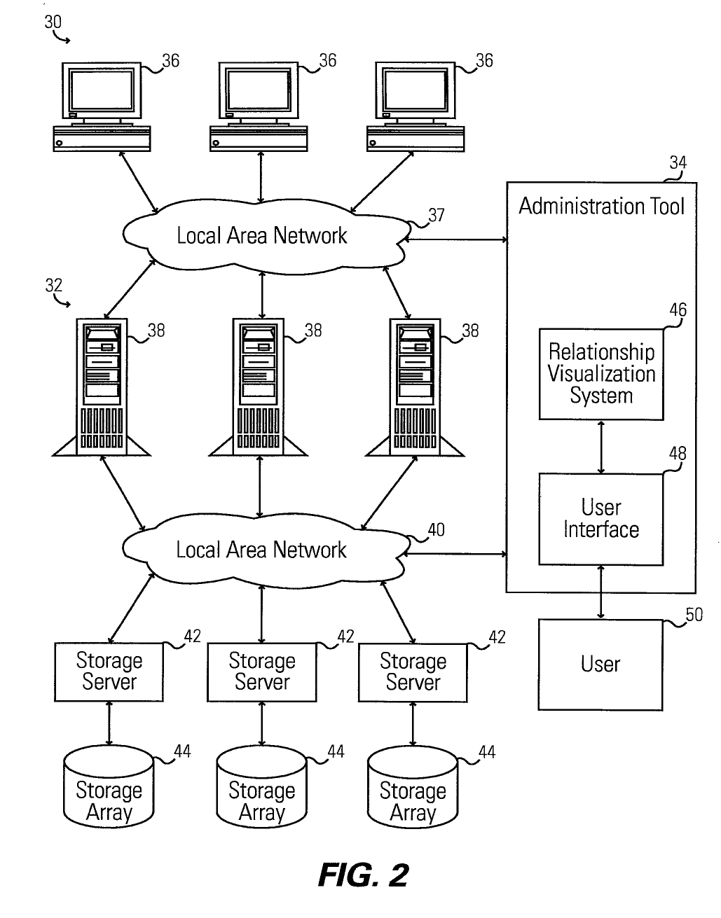

The tabular display of data paths as described in the above-mentioned incorporated by reference patent application entitled “System and Method for Disclosing Relations Between Entities in Support of Information Technology System Visualization and Management” will now be described in more detail. Additional details regarding the tabular display techniques may be found in this incorporated by reference patent application. FIG. 2 shows a diagram of a distributed network system 30 including a computer network 32 in accordance with an embodiment of the invention. System 30 also includes an administration tool 34. Computer network 32 may comprise computers 36, a local area network (LAN) 37, servers 38, storage area network 40, storage servers 42 and storage arrays 44. In other embodiments, computer network 32 may comprise a wide area network, or other networks including intranet and extranets.

It will be appreciated that the network system 30 may include many more devices than are shown in FIG. 2. For example, there may be multiple SANs 40 each having hundreds or thousands of storage servers 42 and storage arrays 44. Administration tool 34 includes a relationship visualization system 46 and a user interface 48. The administration tool 34 allows a user, such an IT administrator to examine a large number of devices in the network system 30 using an attribute-centric view of the devices in the network system 30. An attribute-centric view provides the user with one or more attributes associated with each device in the network system 30. For example, a server 38 may have several attributes including operation system type, operating system patch level, machine type, physical location, user-defined types, installed memory capacity, free disk space, zones and zone sets and the like. The attributes provided by the administration tool 34 may be dynamically determined by the administration tool. The administration tool 34 may gather attributes and attribute values based on the attributes and attribute values possessed by the devices in the network system 30. The administration tool 34 displays in the user interface 48 an attribute-centric view of the network system 30 in accordance with attributes selected by the user 50.

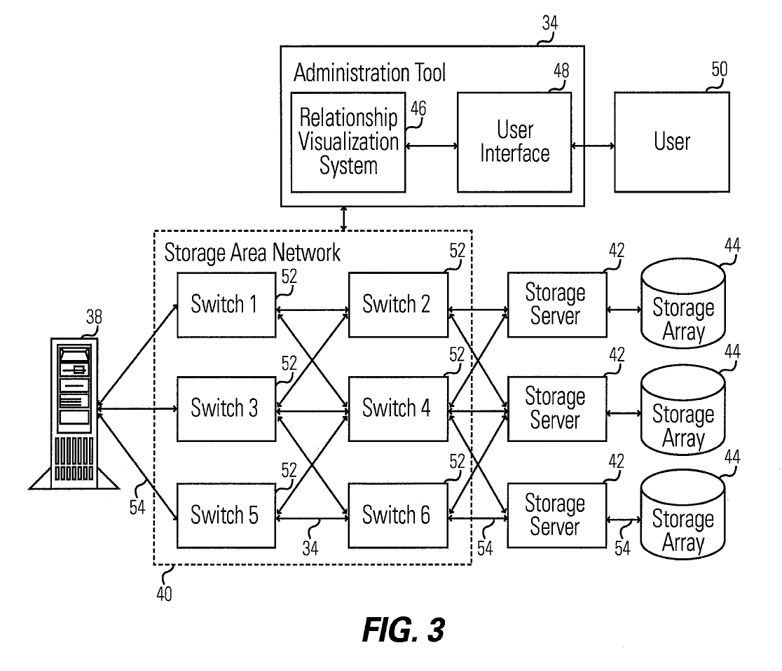

FIG. 3 shows a schematic illustration of communications links and switches in the SAN 40. The SAN 40 comprises switches 52 such as, for example, switches 1-6. Server 38, switches 52, storage servers 42, and storage arrays 44 are connected by means of communications links 54. Relationship realization system 46 displays relationships between entities, such as server 38, storage servers 42, and storage arrays 44. This relationship may be displayed as a data path along which data may be transmitted bidirectionally between server 38 and the storage arrays 44. For example, data may flow from server 38 to the storage array 44 along a particular data path through communication links 54.

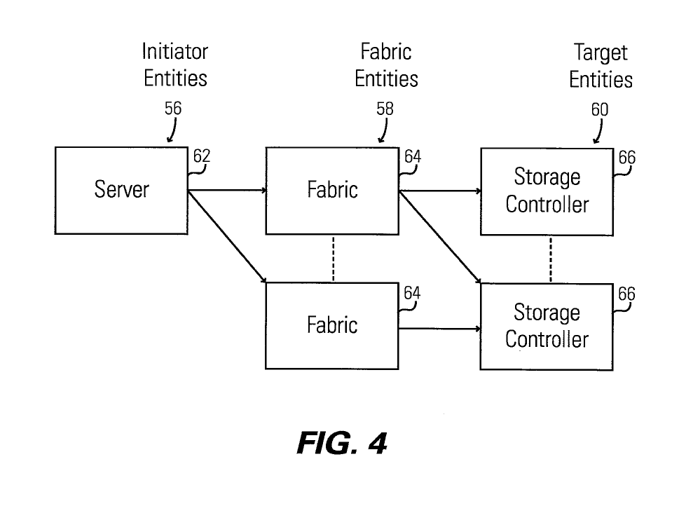

FIG. 4 illustrates a high-level hierarchical display of an exemplary network system such as network system 30 as generated by the relationship visualization system 46. The displayed elements include initiator entities 56, fabric entities 58 and target entities 60. Initiator entities 56 may include a server 62, fabric entities 64 and storage controllers 66. Fabric entities 64 may each comprise, for example, a group of SAN switches 52.

The relationship visualization system 46 may represent data paths specified by the user 50 with the necessary detail and context for entities along the data path. It is not necessary to show all of these separate paths in full detail at the same time. The user 50 can select a particular entity and drill down to a more detailed view that shows only those paths passing through a selected entity. The relationship visualization system 46 lets a user 50 easily switch between the various paths in a “bundle of defined paths. The individual paths are represented as path segments and relevant attributes of these path segments are shown using overlays. This representation allow user 50 to sort the collection of path segments by criteria such as health status, performance, or zones and zone sets.

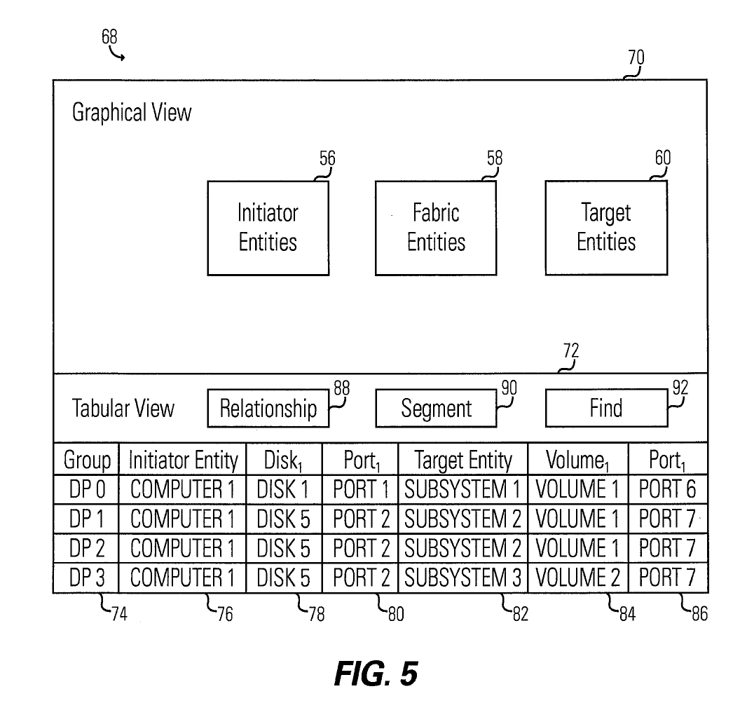

FIG. 5 shows and exemplary screen shot 68 generated by the relationship visualization system 46. Screen shop 68 includes a graphical view 70 and a tabular view 72. The graphical view 70 shows the network system 30 in a high-level form as initiator entitles 56, fabric entities 58 and target entities 60. The tabular view 72 includes rows that represent a relationship or data path between elements and sub-elements of initiator entities 56, fabric entities 58 and target entities 60. The tabular view 72 also includes exemplary columns such as, for example, a group 74, an initiator entity 76, an initiator disk 78, and initiator port 80, a target entity 82, a target volume 84 and a target port 86. Rows in the tabular view 72 can be sorted by column headings. The tabular view 72 reveals information about parts of the data path that may be difficult to represent in the graphical view 70. For example, each entity in the data path may be associated with a plethora of attributes, only some of which need to be represented in the graphical view 70. However, the tabular view 72 can list these attributes easily and in a space effective fashion.

Additional functions may be provided, such as a relationship 88, a segment 90 and a find 92. When looking at the entire path in one row of the table it is not possible to show all detail information for every part of the path, in that the entire path contains a substantial amount of information. Rather, when individual segments are displayed, they are shown as a table and then each part (or segment) of the path occupies an entire row of the table that can contain additional information. User 50 may select segment 90 to view further information about segments of a relationship or data path. Selecting segment 90 expands information presented in the tabular view 72 such that each row corresponds to a segment in the data path. For one or more paths selected, this tab contains a list of “hops” through a displayed topology with detailed information about each segment.

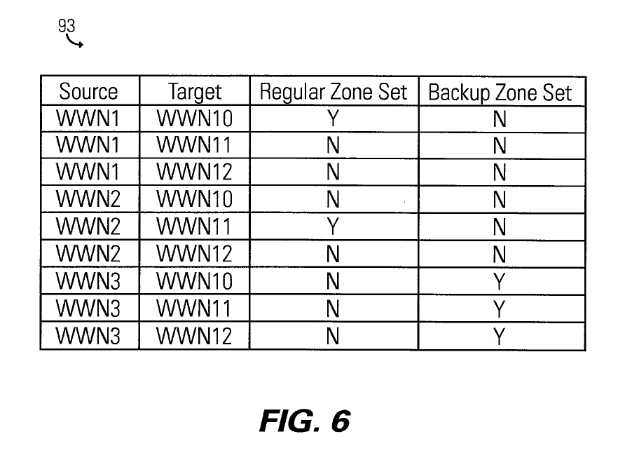

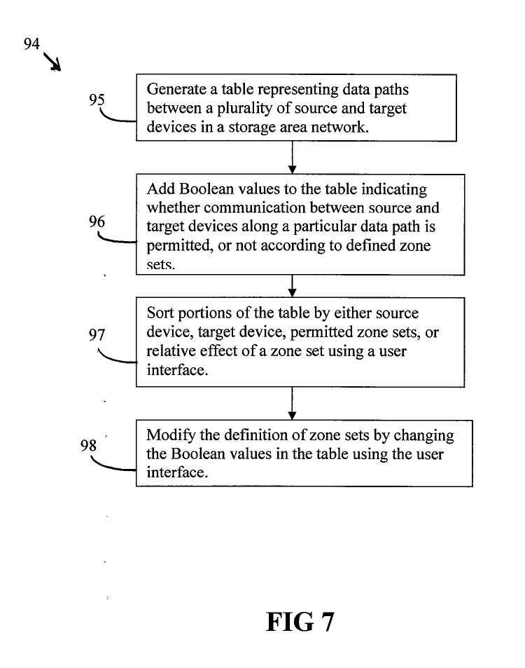

The tabular view 72 may also display information about zones and zone sets. Referring now to FIG. 6, there is shown a tabular display 93 of zone sets in accordance with an embodiment of the present invention. In one embodiment, the tabular display 93 may be displayed in the screen shot 68 shown in FIG. 5, and may generated by the relationship visualization system 46 shown in FIGS. 2 and 3.

The tabular display 93 permits a user to visualize and compare the two zone sets in the example described above in connection with FIG. 1. In more detail, the tabular display 93 includes columns indicating the WWN for various source devices, the WWN for various target devices, as well as Boolean values in the zone set columns. For example, in the first row, in the “Regular Zone Set” column, a “Y” indicates that communication is permitted between the source device and the target device in that row. An “N” in the Backup Zone Set column indicates that communication is not permitted between the source and target devices during backup.

Using tabular display 93 it is much easier than in prior systems to see and compare the differences between what is permitted by the two zone sets, regular zone set and backup zone set. This approach could be extended to support comparison of any number of zone sets. The tabular display 93 may also be sortable by any of the columns, for example, ordering it by source, target, what is permitted by any of the zone sets, and by the relative effects of the zone sets. For example, one may sort the tabular display 93 to first show those source/target pairs permitted by both zone sets, then those permitted by the first zone set, then those pairs permitted by the second zone set, then all the pairs prohibited by both zone sets.

In some embodiments, the tabular display 93 may further be used to actually manipulate the zone set definitions by allowing users to edit the Boolean values in the table to determine zone set definitions. The columns indicating whether communication is permitted may also be editable, so the user can quickly and easily permit or prohibit communication between a certain pair of devices. Unlike conventional zone/zone set lists, where adding or removing members can have unintended consequences, the table is an unambiguous interface, with the user's intentions clearly displayed. Once the user has created a tabular description of a zone set, those skilled in the art will appreciate that one may configure the system to automatically generate equivalent zone lists to use in the back-end. In this way, changes need only be made in the user interface.

It may be noted that the tabular display 93 has limitations with respect to scaling, due to its combinatoric nature. For example, to show a connectivity table for 100 computers and 100 storage subsystems would require 10,000 rows, even if each computer is only allowed to connect to a single storage subsystem. Filtering may be employed, for example, to allow a user to exclude from the table pairs of devices for which communication is disallowed in any displayed zone set. Even so, the data path views, such as those described in FIG. 6 are most often invoked with a relatively small set of hosts or storage subsystems.

Another feature that may be useful for managing larger numbers of devices is hierarchical grouping of source or target devices. For example, computers may be grouped into Linux and Windows groups, with each group having uniform access to certain storage subsystems. Hierarchical grouping (or, possibly, coloring of entries) may also be useful in the case of multi-path configurations, where a single host is connected to a SAN through multiple ports for increased performance and redundancy. This would ensure that all related ports for a device were grouped and managed together.

The tabular view can also be extended to support another type of zoning, often referred to as Port Zoning, or Hard Zoning. Hard Zoning is a more stringent form of zoning where the SAN network switches permit traffic only between certain external facing network ports on the switches. The goal is the same, to limit access between certain devices, but the definition is different, referring to switch ports instead of device WWNs. With Hard Zoning, the specification of zones requires 5 steps: 1) deciding which computer should communicate with which storage subsystem; 2) look up the computer's network port(s); 3) look up the SAN network switch port(s) that the computer port(s) are connected to; 4) look up the storage subsystem's network port(s); and 5) look up the SAN network switch port(s) that the storage subsystem port(s) are connected to.

With Hard Zoning, a similar tabular view as the one shown in FIG. 6 could be used by the user to express their intent with respect to connectivity, and this intent could be automatically mapped to an appropriate switch Hard Zoning specification. One issue with Hard Zoning is that the zoning can be broken if a device is moved to a different port on the SAN network. Given that the tabular view captures the user's intent for connectivity, this feature could be used to automatically update the zoning definition when a device moves.

The tabular display 93, as shown in FIG. 6, may also be used for defining, viewing, and comparing zone sets that work across multiple SAN fabrics. With existing technology, users must define and reconcile zones and zone sets independently for each SAN fabric. This process is error prone, since inconsistencies can easily creep in between the different zone sets for different fabrics. In some embodiments of the invention the tabular view may be used as a means of defining cross-fabric zone sets (essentially a set of zone sets). If the user selects more than one fabric and wishes to define zoning, the table could show all pairs of components that are capable of communicating across the different fabrics, with one column for each fabric indicating whether the cross-fabric zone set permits communication on that fabric. Using this mechanism, it would be immediately clear to a user if a cross-fabric zone set permitted communication between components over some fabrics, but not others. The resulting tabular description could easily and unambiguously be transformed into a set of zone sets, one for each fabric that fulfills the user's connectivity requirements.

FIG. 7 shows a flowchart of a process 94 for displaying and comparing zoning configurations in accordance with an embodiment of the invention. In step 95, a table is generated representing data paths between a plurality of source and target devices in a storage area network. This may comprise, for example, the table shown in the tabular view 93 in FIG. 6. Boolean values are added to the table indicating whether communication between source and target devices along a particular data path is permitted, or not, according to defined zone sets, in step 96. In step 97, portions of the table are sorted by either source device, target device, permitted zone sets, or relative effect of a zone set using a user interface. In step 98, the definition of zone sets is modified by changing the Boolean values in the table using the user interface.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wire line, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

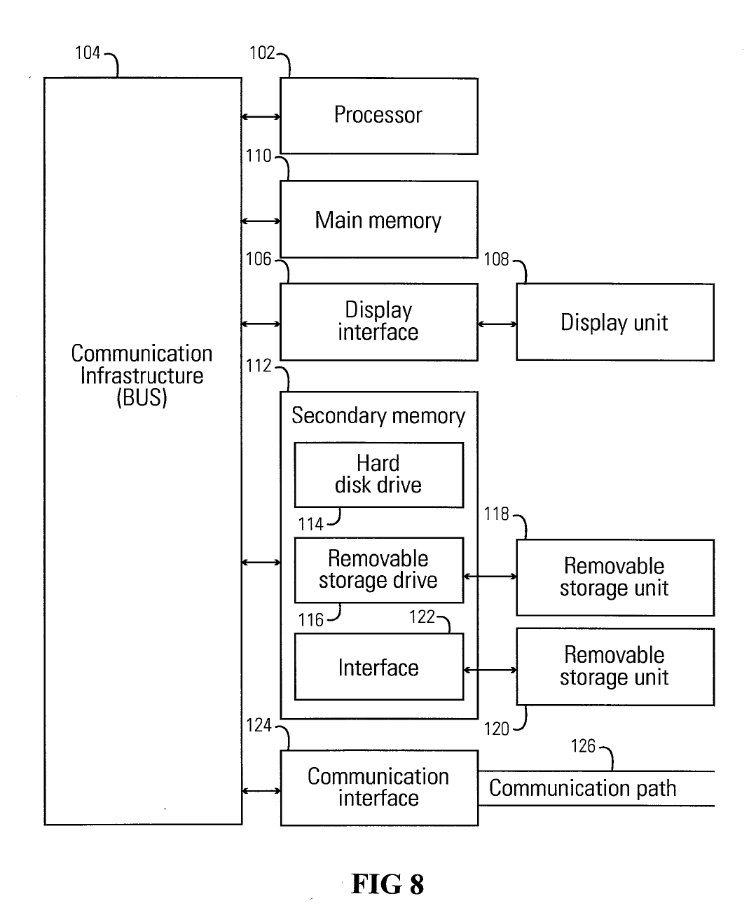

FIG. 8 is a high level block diagram showing an information processing system useful for implementing one embodiment of the present invention. The computer system includes one or more processors, such as processor 102. The processor 102 is connected to a communication infrastructure 104 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 106 that forwards graphics, text, and other data from the communication infrastructure 104 (or from a frame buffer not shown) for display on a display unit 108. The computer system also includes a main memory 110, preferably random access memory (RAM), and may also include a secondary memory 112. The secondary memory 112 may include, for example, a hard disk drive 114 and/or a removable storage drive 116, representing, for example, a floppy disk drive, a magnetic tape drive, or an optical disk drive. The removable storage drive 116 reads from and/or writes to a removable storage unit 118 in a manner well known to those having ordinary skill in the art. Removable storage unit 118 represents, for example, a floppy disk, a compact disc, a magnetic tape, or an optical disk, etc. which is read by and written to by removable storage drive 116. As will be appreciated, the removable storage unit 118 includes a computer readable medium having stored therein computer software and/or data.

In alternative embodiments, the secondary memory 112 may include other similar means for allowing computer programs or other instructions to be loaded into the computer system. Such means may include, for example, a removable storage unit 120 and an interface 122. Examples of such means may include a program cartridge and cartridge interface (such as that found in video game devices), a removable memory chip (such as an EPROM, or PROM) and associated socket, and other removable storage units 120 and interfaces 122 which allow software and data to be transferred from the removable storage unit 120 to the computer system.

The computer system may also include a communications interface 124. Communications interface 124 allows software and data to be transferred between the computer system and external devices. Examples of communications interface 124 may include a modem, a network interface (such as an Ethernet card), a communications port, or a PCMCIA slot and card, etc. Software and data transferred via communications interface 124 are in the form of signals which may be, for example, electronic, electromagnetic, optical, or other signals capable of being received by communications interface 124. These signals are provided to communications interface 124 via a communications path (i.e., channel) 126. This communications path 126 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 110 and secondary memory 112, removable storage drive 116, and a hard disk installed in hard disk drive 114.

Computer programs (also called computer control logic) are stored in main memory 110 and/or secondary memory 112. Computer programs may also be received via communications interface 124. Such computer programs, when executed, enable the computer system to perform the features of the present invention as discussed herein. In particular, the computer programs, when executed, enable the processor 102 to perform the features of the computer system. Accordingly, such computer programs represent controllers of the computer system.

From the above description, it can be seen that the present invention provides a system, computer program product, and method for implementing the embodiments of the invention. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
generating a table representing data paths between a plurality of source and target devices in a storage area network;
adding symbols to said table, said symbols indicating whether communication between particular source and target devices along a particular data path is permitted, or not permitted, according to defined zone sets; and
sorting portions of said table according to at least one desired parameter using a user interface.

2. A method according to claim 1 wherein said sorting comprises sorting portions of said table according to at least one of the following parameters: source device, target device, permitted zone sets, and relative effect of a zone set.

3. A method according to claim 2 wherein said table includes separate columns representing said source devices, said target devices, and said defined zone sets, and wherein said symbols in a column for a zone set indicate whether communication along a data path is permitted or not.

4. A method according to claim 3 wherein said table includes rows with symbols identifying particular sources and targets, and said symbols in a row indicate whether communication between said particular source and target is permitted for a particular zone set.

5. A method according to claim 3 further comprising modifying said zone set in response to a change in said symbol made through said user interface.

6. A method according to claim 1 further comprising filtering said table by displaying only a subset of all possible data paths in said storage area network.

7. A method according to claim 1 further comprising grouping said source and target devices in said table according to a hierarchical ordering of said source and target devices.

8. A method comprising:
generating a table representing data paths between a plurality of source and target devices in a storage area network;
adding values to said table indicating whether communication between said source and said target devices along a particular data path is permitted, or not permitted according to defined zone sets; and
defining a new zone set in response to a change in at least one of said values in said table made through a user interface.

9. A method according to claim 8 wherein said storage area network includes storage area network switch ports, and said defined zone sets are Hard Zoning zone sets.

10. A method according to claim 9 further comprising automatically mapping said values in said table to a corresponding switch port zoning specification.

11. A method according to claim 10 further comprising:
moving at least one of said source and target devices; and
automatically updating said switch port zoning specification in response to said moving.

12. A method according to claim 8 wherein said generating a table comprises generating a table representing data paths between a plurality of source and target devices in a plurality of storage area networks.

13. A method according to claim 8 further comprising sorting portions of said table according to at least one desired parameter using said user interface.

14. A method according to claim 13 wherein said sorting comprises sorting portions of said table according to at least one of the following parameters: source device, target device, permitted zone sets, and relative effect of a zone set.

15. A system comprising:
a storage area network including at least one source device and at least one target device;
a display showing a table representing said source and target devices, said table representing data paths between a plurality of source and target devices in a storage area network, said table including symbols indicating whether communication between particular source and target devices along a particular data path is permitted, or not permitted, according to defined zone sets; and
a user interface for modifying said table.

16. A system according to claim 15 further comprising means for updating said defined zone sets in response to modifications made to said symbols made using said user interface.

17. A system according to claim 15 wherein said zone sets include regular and backup zone sets having different corresponding symbols in said table.

18. A system according to claim 15 wherein said at least one source device includes a host server and wherein said at least one target device includes a storage subsystem.

19. A computer program product for displaying and comparing storage zoning configurations, said computer program product comprising:
a computer usable medium having computer usable program code embodied therewith, said computer usable program code comprising:
computer usable program code configured to:
generate a table representing data paths between a plurality of source and target devices in a storage area network;
add values to said table indicating whether communication between said source and said target devices along a particular data path is permitted, or not permitted according to defined zone sets; and
define a new zone set in response to a change in at least one of said values in said table made through a user interface.

20. A computer program product according to claim 19 wherein said computer usable program code is further configured to sort portions of said table according to at least one desired parameter using said user interface.
